(19) United States
(12) Patent Application Publication
(10) Pub. No.: US 2010/0277329 A1
(43) Pub. Date: Nov. 4, 2010

(54) MONITORING A FLEXIBLE POWER CABLE

(75) Inventor: Thomas Worzyk, Rodeby (SE)

Correspondence Address: VENABLE LLP, P.O. BOX 34385, WASHINGTON, DC, 20043-9998, US

(73) Assignee: ABB Technology Ltd., Zurich (CH)

(21) Appl. No.: 12/518,932

(22) PCT Filed: Nov. 28, 2007
(86) PCT No.: PCT/SE07/73033

§ 371 Date: Jun. 12, 2009

(30) Foreign Application Priority Data
Dec. 12, 2006 (SE) 0602678-5

(51) Int. Cl. G08B 21/00; G01N 3/20

(52) U.S. Cl. 340/679; 702/42

(57) ABSTRACT

An offshore monitoring system, for an electrical power cable connected between a fixed point and a movable point, or for an electrical power cable connecting two movable points. The system comprises at least one optical fiber acting as a continuously distributed strain measurement sensor attached to or arranged in said power cable, a device arranged for sending optical signals and a device arranged for receiving optical signals to determine the time variant bending of said power cable.

### TECHNICAL AREA

The present invention relates to system for monitoring the bending and strain of a power cable connected to a moving offshore platform by measuring the strain in optical fibers attached to or incorporated into the power cable.

### TECHNICAL BACKGROUND

Offshore installations such as oil/gas rigs, processing platforms, semi-submersible installations, etc, are more and more often connected with power cables to shore-based installations, fixed sub sea installations or another offshore installation. In case of floating rigs the power cables are subjected to repeated motions and bendings due to wave swell, wind pressure and/or tidal motions.

To tolerate the motions of the floating offshore installation the power cables have to be somewhat flexible. The motions of the installation and the resulting bendings of the power cables however, can cause limitations for the useful life of the cable. The lifetime of a power cable is not only determined by the number of bendings it is subjected to but also by the amplitude of the bending, the actual strain in any point along the cable, the frequency of the bending etc.

Using optical fibers for strain measurements are known in the art but the prior art suggests solutions that uses a number of sensor points along the optical path.

U.S. Pat. No. 6,876,786 entitled “Fiber-optic sensing system for distributed detection and localization of alarm conditions” describes an optical fiber sensor system comprising of an optical fiber including a plurality of sensitive elements. The system is aimed for structural monitoring of large structures using in-fiber Bragg gratings. Bragg gratings have narrow reflection spectral bands whose position within the optical spectrum depends on certain conditions, like temperature and axial strain.

The U.S. Pat. No. 6,876,786 states “it is well recognized that complete sensing systems based on in-fiber weakly reflective Bragg gratings which includes optical fiber sensing network, signal demodulation and de-multiplexing subsystems are still quite expensive”. The Bragg grating sensors are not only expensive but they are sensitive and the installation is therefore more complicated.

U.S. Pat. No. 5,118,931 entitled “Fiber optic microbending sensor arrays including microbend sensors sensitive over different bands of wavelengths of light” describes a fiber optic sensing system with embedded microbend sensors along the optical path that measure strain.

The microbend sensors could provide a simple solution for many applications and have the capability for locating a disturbance by using OTDR technique but this method suffers from a high level of losses of the signal pulse energy in the sensing optical cable and very small energy of back-scattered light signal. This limits significantly the sensing length of the detector system. A disadvantage for the use of microbend sensors in cables is the need for spatially enlarged portions on or in the cables to accommodate the sensors.

A solution to increase the total sensing length of the system would be to divide the sensing length into several parts each connected to an individual optical fiber. The obvious drawback of this solution is the increased complexity in installing and with measuring one bend axis with several different optical cables.

### SUMMARY OF THE INVENTION

The preferred embodiment of the present invention is to provide a system to monitor the bending to estimate the strain of a power cable connected between a fixed point and one movable point or between two movable points. The strain on the power cable arises from the bending of the cable caused by the movement of the movable point. The fixed point could be a land based installation or a fixed sub sea installation and the moveable point could be a floating installation or platform. If the system comprises two movable points, the points could be floating installations or platforms.

The power cable is used for delivery of electrical power to or from the platform. The movement and bending of the power cable is measured by measuring the strain in optical fibers attached to or incorporated in the power cable. A bend in the power cable will give rise to a strain in the optical fiber and this strain will change the optical properties of the fiber. The changing optical properties will change the spectral properties of light scattering which can be measured and analyzed by an optical time domain reflectometer (OTDR) or an optical frequency domain reflectometer (OFDR). From the strain in the optical fiber, the movement or bending of the power cable can be calculated and from the estimation of power cable bending, the strain in the power cable can be calculated.

The present invention proposes a system to monitor the actual bendings of the power cable to a floating offshore installation in real-time. This enables a monitoring unit to record the bendings of the power cable for evaluation. From this evaluation which can be software-based or expert based, the remaining useful life of the power cable can be estimated. Maintenance/repair operations can be planned and the risk for an outage (which is extremely costly in offshore installations) can be reduced.

The present invention is less costly and easier to install that a solution with a discrete number of transducers along the optical path as described in the prior art. The fiber optic sensors can be included in the power cable at the production of the cable. It also less costly to install a small number of continuous fibres during manufacturing compared to the installation of discrete strain sensors.

The present invention requires the installation of at least one optical fiber to measuring the stress in the whole sensing length in one stress axis, where as the high level of losses of the signal pulse energy in the transducers in the prior art might require several optical fibers, each measuring the stress in only a part of the whole sensing length.

In the present invention the power cable can be conducting AC (alternating current) or DC (direct current) and the voltage level in the power cable can be medium voltage (1-50 kV) or high voltage (>50 kV).

According to an embodiment of the invention, the system comprising at least one optical fiber acting as a continuously distributed strain measurement sensor, and the fiber is attached to or arranged in said power cable, a device arranged for sending optical signals into said optical fibers and a device arranged for receiving optical signals from said optical fibers, and an device arranged for analyzing the received optical signals to determine the time variant bending of said power cable.

According to an embodiment of the invention, the optical fiber is attached on the outside of the electrical power cable.

According to an embodiment of the invention, the optical fiber is arranged in one of the materials in the cable or between two different materials in the power cable.

According to an embodiment of the invention, one or more of the armoring wires in the power cable are replaced by optical fibers.

According to an embodiment of the invention, the numbers of optical fibers are two or greater and the optical fibers are positioned equidistant around the power cable.

According to an embodiment of the invention, two optical fibers are positioned 90 degrees apart with respect to the circumference of the power cable.

According to an embodiment of the invention, the optical fibers are arranged straight along the power cable.

According to an embodiment of the invention, the optical fibers are wound around the power cable in a spiraling or helicoidal geometry.

According to an embodiment of the invention, the optical fibers are included into the power cable during production of said cable.

According to an embodiment of the invention, said optical signals are monochromatic pulses.

According to an embodiment of the invention, said optical signals is a monochromatic continuous wave.

According to an embodiment of the invention, said optical signals are monochromatic continuous waves with amplitude modulation.

According to an embodiment of the invention, said optical signals received from said optical fibers are analyzed by OTDR and/or OFDR.

According to an embodiment of the invention, said analysis is adapted for estimating the bending of said power cable.

According to an embodiment of the invention, said monitoring system is adapted to give an alarm if the estimated bending of said power cable exceeds an upper value.

According to an embodiment of the invention, said monitoring system is adapted to record the bending of said power cable.

According to an embodiment of the invention, said monitoring system is adapted to calculate an accumulated total bending stress of said power cable.

According to an embodiment of the invention, said monitoring system is adapted to estimate time to future maintenance/repair from accumulated bending stresses of said power cable.

According to an embodiment of the invention, said power cable is bundled with other pipes and tubing and the monitoring system is adapted to estimate accumulated total bending stress of the bundle.

### BRIEF DESCRIPTION OF THE DRAWINGS

The invention will be elucidated by reference to an embodiment partially illustrated in the drawings.

FIG. 1 illustrates a schematic diagram of a cross-section of a high voltage power cable.

FIG. 2 shows a schematic picture of a floating offshore installation connected to a fixed sub sea installation.

FIG. 3 shows a schematic picture of the Rayleigh, Brillouin and Raman scattering.

FIG. 4 shows schematically possible placements of optic fibers around a power cable.

### DETAILED DESCRIPTION OF THE EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

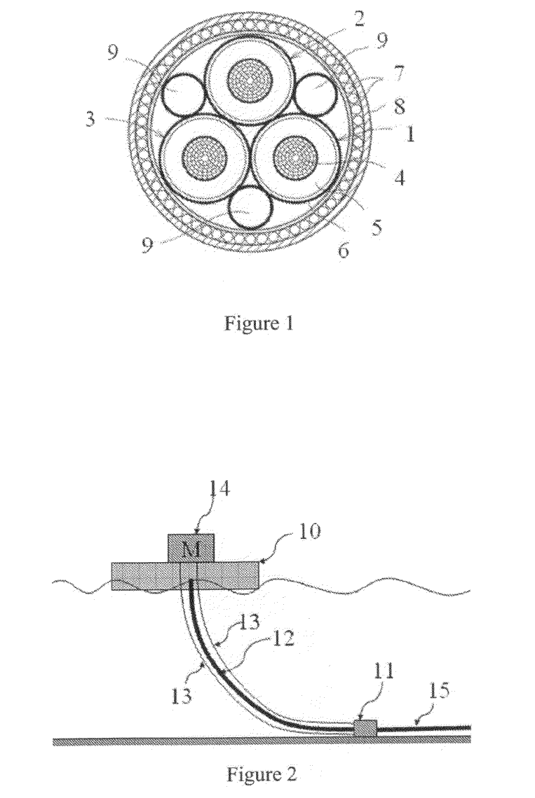

FIG. 1 shows a schematic diagram of a cross-section of a high voltage power cable on which the present invention could be used. A high voltage power cable can consist of one, two, three or more single-conductor cables. The power cable shown in FIG. 1 consists of three single-conductor cable cores 1-3. Each of the single-conductor cable cores having a metallic centre conductor 4 enclosed in an insulation layer 5 surrounded by a cable screen 6. The cable cores are provided with one or more common outer layers, such as armoring wires 7 and an outer jacket 8, to keep the cable cores together and to protect them mechanically. Filler ropes 9 in the space between the cable cores are widely used to build up a circular contour of the cable and to avoid three-core cables with a triangular outer contour. Circular cables are easier to handle in cable production and installation.

The present invention is to include optical fibers in the buildup of the power cable. There are many possible locations where one could include one or more optical fibers in the power cable. The fiber optic sensor can be attached, e.g., to the cable screen 6, filler ropes 9, or among the armoring wires 7, or between layers in the outer jacket 8.

Using optical fiber as sensor has several advantages in the suggested offshore application. The optical fiber consist of electrically insulating materials and thus no electric cables are required, which makes it possible use them in high voltage and high current environments such as having the fiber attached to a power cable. The material in the optical fiber is chemically passive and not subject to, for example, to corrosion in saltwater.

Furthermore, the optical fibers are immune to electromagnetic interference (EMI) and they have a very wide operation temperature range.

FIG. 2 shows a schematic picture of a floating offshore installation 10 connected to a fixed sub sea installation 11 by a connector 12. The connector 12 can be a power cable that provides power to the floating installation. Attached to the connector are one or more optical fibers 13. A measurement/monitoring device 14 sends optical signals and analyses the reflected signals to determine the bending or strain on the connector in real time. The device 14 also determines the frequency and amplitude of the stress that the connector is subjected to. The device 14 can also include the function of estimating the remaining useful life of the connector based on past stress and/or an estimation of future stresses. With this estimation of the remaining useful life, the maintenance and repair operations can be planned and the risk for interruptions i.e. power outages (which all are extremely costly in offshore installations) can be greatly reduced.

Optical fibers in or bonded to a power cable that connects a fixed point with a floating platform will experience tension when the connector (in the form of a power cable or a “umbilical cord” connection) is exposed to bending due to the movement of a floating platform.

In the prior art the microbend sensors or the Bragg grating sensors measure the bending at points along the measurement sensing length. In the present invention the whole optical fiber itself is a strain measurement sensor that measures strain continuously along the whole measurement sensing length.

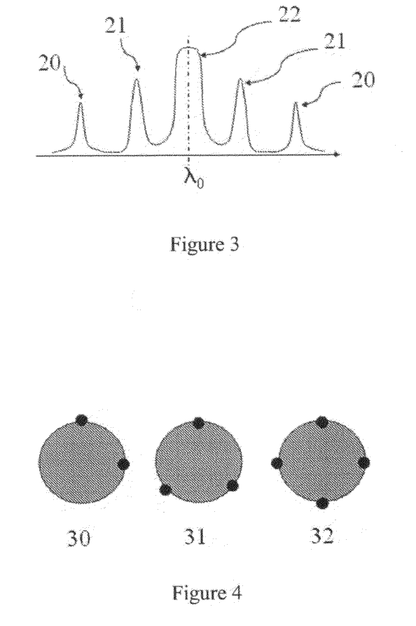

FIG. 3 shows a schematic picture of the Rayleigh 22, Brillouin 21 and Raman 20 scattering.

Light traveling along the core of the optical fiber is subjected to so called Rayleigh scattering 22, caused by impurities and crystal lattice boundaries. The Raman 20 and Brillouin 21 effect generate spectral side bands in the scattered light beside the central main light wavelength. A fiber subjected to mechanical strain changes its spectral characteristics by a wavelength shift of the Brillouin 21 spectrum as a function of the strain.

The present invention does not use specific sensors/transducers such as microbending sensors or fiber Bragg gratings sensors, but rather the fiber itself. The principle of sensing can then be based on Raman scattering or Brillouin scattering. One can e.g. exploit the temperature or strain dependence of the Brillouin frequency shift.

FIG. 4 shows schematically possible placements of optic fibers in or around a power cable.

A typical installation would include four fibers 32 placed with 90 degrees distance around the connector. Other embodiments of the present invention would include three optical fibers 31 or two optical fibers 30. For example, for a power cable the optical fibers could be placed between lead sheath and PE-sheath of the flexible cable. A suitable lay-length of the fibers ensures that there will be a measurable strain on the fiber as a response to expected bendings.

However, the lay-length should be clearly longer than the spatial resolution of the monitoring unit. The fibers are connected to the monitoring unit placed on-board of the offshore installation. The unit can monitor the attenuation vs. position curve of the connection in real-time and record it. The curve of spectral intensity as a function of time can be translation to a time-domain strain curve. Finally, the bending of the cable over time can be calculated, and accumulated bending stresses on the cable can be estimated. The bending stresses estimated by this calculation are, for a power cable, the bending stress of the cable sheath.

There exists a risk that the optical fibers embedded or attached to the power cable might be damaged during the installation of the cable in the offshore installation. One embodiment of the present invention is to install the power cable with redundant optical fibers. If four optical fibers are needed to monitor the movements and bending of a cable installation, the cable might be fitted with six or eight optical fibers to ensure redundancy.

The optical fibers can be arranged straight along the power cable or the optical fibers can be wound around the power cable in a spiraling or helicoidal geometry.

Although the embodiment described here shows the location of the fibers at certain positions outside or within the cable, the invention can be used in many more arrangements. Submarine electric cables can include many different layers such as armoring, bedding, plastic and metallic sheaths, screen layers, jackets, fillers, insulation layers, semi-conducting layers and conductors in various orders. The sensing fibers according to the invention can be arranged between or inside any of these constituents.

Floating offshore installations are often connected with other offshore installations or land based installation by what is known in the art as an “umbilical cord” connection where the umbilical cord is a flexible connection with power cable(s), and any of; material transport piping, bundles of signal connections (optical and electrical) all in a flexible sheath or tubing. The present invention can be used to estimate the bending of this umbilical cord connection and monitor the strains, stress and fatigue of the connection.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An offshore monitoring system, for a power cable connected between a fixed point and a movable point, or for a power cable connecting two movable points, the system comprising:
at least one optical fiber acting as a continuously distributed strain measurement sensor, wherein the at least one fiber is attached to or arranged in said power cable,
a device arranged for sending optical signals into said at least one optical fiber,
a device arranged for receiving optical signals from said at least one optical fiber, and
a device arranged for analyzing the received optical signals to determine a time variant bending of said power cable.

2. The offshore monitoring system according to claim 1, wherein the at least one optical fiber is attached on an outside of the electrical power cable.

3. The offshore monitoring system according to claim 1, wherein the optical fiber is arranged in a material in the power cable or between two different materials in the power cable.

4. The offshore monitoring system according to claim 1, wherein at least one armoring wires in the power cable is replaced by optical fibers.

5. The offshore monitoring system according to claim 1, wherein a number of optical fibers are two or greater and the optical fibers are positioned equidistant around the power cable.

6. The offshore monitoring system according to claim 1, wherein two optical fibers are positioned 90 degrees apart with respect to a circumference of the power cable.

7. The offshore monitoring system according to claim 1, wherein the at least one optical fiber is arranged parallel to a long axis of the power cable.

8. The offshore monitoring system according to claim 1, wherein the at least one optical fiber is wound around the power cable in a spiraling or helicoidal geometry.

9. The offshore monitoring system according to claim 1, wherein the at least one optical fiber is included into the power cable during production of said cable.

10. The offshore monitoring system according to claim 1, wherein said optical signals comprise monochromatic pulses.

11. The offshore monitoring system according to claim 1, wherein said optical signals comprise a monochromatic continuous wave.

12. The offshore monitoring system according to claim 1, wherein said optical signals comprise monochromatic continuous waves with amplitude modulation.

13. The offshore monitoring system according to claim 1, wherein said optical signals received from said at least one optical fiber are analyzed by OTDR and/or OFDR.

14. The offshore monitoring system according to claim 1, wherein said analysis is adapted for estimating the bending of said power cable.

15. The offshore monitoring system according to claim 14, wherein said monitoring system is adapted to give an alarm if the estimated bending of said power cable exceeds an upper value.

16. The offshore monitoring system according to claim 14, wherein said monitoring system is adapted to record the bending of said power cable.

17. The offshore monitoring system according to claim 14, wherein said monitoring system is adapted to calculate an accumulated total bending stress of said power cable.

18. The offshore monitoring system according to claim 14, wherein said monitoring system is adapted to estimate time to future maintenance/repair from accumulated bending stresses of said power cable.

19. The offshore monitoring system according to claim 14, wherein said monitoring system is adapted to estimate future bending stress from accumulated measured bending stresses of said power cable.

20. The offshore monitoring system according to claim 1, wherein said power cable is bundled with other pipes and tubing and the monitoring system is adapted to estimate accumulated total bending stress of the bundle.
